(19) United States
(12) Patent Application Publication
(10) Pub. No.: US 2021/0211626 A1
(43) Pub. Date: Jul. 8, 2021

(54) BAYER IMAGE DETECTION METHOD AND DEVICE, AND MACHINE READABLE STORAGE MEDIUM

(71) Applicant: SZ DJI TECHNOLOGY CO., LTD., Shenzhen (CN)

(72) Inventors: Xing CHEN, Shenzhen (CN); Junping MA, Shenzhen (CN); Qiang ZHANG, Shenzhen (CN)

(73) Assignee: SZ DJI TECHNOLOGY CO., LTD., Shenzhen (CN)

(21) Appl. No.: 17/201,132

(22) Filed: Mar. 15, 2021

Related U.S. Application Data
(63) Continuation of application No. PCT/CN2018/106509, filed on Sep. 19, 2018.

(51) Int. Cl. H04N 9/64; H04N 9/04; H04N 9/73

(52) U.S. Cl. CPC H04N 9/646; H04N 9/735; H04N 9/0451

(57) ABSTRACT

A Bayer image detection method and device, and a machine readable storage medium are provided. The method includes: obtaining a Bayer image from an image sensor, the Bayer image including at least one Bayer image unit, the Bayer image unit including four pixels; detecting a distribution mode of two pixels with maximum pixel values among the four pixels in the Bayer image unit; and determining a detection result of the Bayer image according to the distribution mode. In this way, it is unnecessary to detect the entire image in some exemplary embodiments, and it can be determined, based on merely one Bayer image unit, whether the Bayer image has a missing row or missing column, thereby achieving the effect of quickly detecting an error in the Bayer image. An error in the Bayer image can be positioned quickly, which helps improve correction efficiency of the Bayer image.

### RELATED APPLICATIONS

This application is a continuation application of PCT application No. PCT/CN2018/106509, filed on Sep. 19, 2018, and the content of which is incorporated herein by reference in its entirety.

### TECHNICAL FIELD

The present disclosure relates to the technical field of image processing, and in particular, to a Bayer image detection method and device, and a machine readable storage medium.

### BACKGROUND

Currently, images outputted by a digital camera through an image sensor are mostly Bayer images in a monochromatic format, for example, (R/Gr/Gb/B), (Gr/R/B/Gb), (Gb/B/R/Gr), and (B/Gb/Gr/R). When a high-speed interface receives an image from the image sensor, it is possible to miss one row and/or one column, causing the Bayer image to change. Therefore, row missing or column missing of a Bayer image needs to be detected in time, so as to facilitate a timely correction of the Bayer image.

Rows of a Bayer image are usually counted to determine whether an image frame has a row missing. However, in the row counting method, the number of rows in each image frame can be compared with the number of rows of a sensor only after the transmission of the image frame is ended, which leads to low detection efficiency and low correction efficiency.

### SUMMARY

The present disclosure provides a Bayer image detection method and device, and a machine readable storage medium.

According to a first aspect of the present disclosure, a Bayer image detection method is provided, including: obtaining a Bayer image from an image sensor, where the Bayer image includes at least one Bayer image unit, and each of the at least one Bayer image unit includes four pixels; detecting a distribution mode of two pixels with maximum pixel values among the four pixels in the Bayer image unit; and determining a detection result of a status of the Bayer image based on the distribution mode.

According to a second aspect of the present disclosure, a Bayer image detection device is provided, including: an image sensor; at least one storage device storing a set of instructions for detecting a Bayer image; and at least one processor in communication with the at least one storage device, where during operation, the at least one processor executes the set of instructions to: obtain a Bayer image from an image sensor, where the Bayer image includes at least one Bayer image unit, and each of the at least one Bayer image unit includes four pixels; detect a distribution mode of two pixels with maximum pixel values among the four pixels in the Bayer image unit; and determining a detection result of a status of the Bayer image based on the distribution mode.

According to the foregoing technical solutions, in some exemplary embodiments, a Bayer image is obtained from an image sensor, where the Bayer image includes at least one Bayer image unit, and the Bayer image unit includes four pixels. Then, after a distribution mode of two pixels with maximum pixel values among the four pixels in the Bayer image unit is detected, a detection result of the Bayer image is determined based on the distribution mode. In this way, in some exemplary embodiments, it is unnecessary to detect the entire image, and it can be determined, based on merely one Bayer image unit, whether the Bayer image has a missing row or missing column, thereby achieving the effect of quickly detecting an error in the Bayer image. In addition, in some exemplary embodiments, since an error is positioned based on the Bayer image unit(s) of each row or column, the error in the Bayer image can be positioned quickly, which helps increase correction efficiency of the Bayer image.

### BRIEF DESCRIPTION OF THE DRAWINGS

In order to describe the technical solutions in some exemplary embodiments of the present disclosure more clearly, the accompanying drawings to describe the embodiments will be briefly described below. Apparently, the accompanying drawings described below are only some exemplary embodiments of the present disclosure. Those of ordinary skill in the art may further obtain other accompanying drawings based on these accompanying drawings without inventive efforts.

FIG. 1 is a diagram of an application scenario of a Bayer image detection method according to some exemplary embodiments of the present disclosure;

FIG. 2 is a schematic flowchart of a Bayer image detection method according to some exemplary embodiments of the present disclosure;

FIG. 3 is a schematic diagram of a part of a Bayer image according to some exemplary embodiments of the present disclosure;

FIG. 4A is a schematic diagram of a P mode according to some exemplary embodiments of the present disclosure;

FIG. 4B is a schematic diagram of an N mode according to some exemplary embodiments of the present disclosure;

FIG. 5A is a schematic diagram of a Bayer image under normal conditions according to some exemplary embodiments of the present disclosure;

FIG. 5B is a schematic diagram of a Bayer image with one row of pixels missing according to some exemplary embodiments of the present disclosure;

FIG. 5C is a schematic diagram of a Bayer image with one column of pixels missing according to some exemplary embodiments of the present disclosure;

FIG. 6 is a schematic flowchart of a Bayer image detection method according to some exemplary embodiments of the present disclosure;

FIG. 7 is a schematic flowchart of a Bayer image detection method according to some exemplary embodiments of the present disclosure;

FIG. 8 is a schematic diagram of a Bayer image with one row of pixels and one column of pixels missing at the same time according to some exemplary embodiments of the present disclosure;

FIG. 9 is a schematic flowchart of a Bayer image detection method according to some exemplary embodiments of the present disclosure;

FIG. 10 is a schematic flowchart of a Bayer image detection method according to some exemplary embodiments of the present disclosure;

FIG. 11 is a schematic flowchart of a Bayer image detection method according to some exemplary embodiments of the present disclosure; and

FIG. 12 is a block diagram of a Bayer image detection device according to some exemplary embodiments of the present disclosure.

### DETAILED DESCRIPTION

The following clearly describes the technical solutions in some exemplary embodiments of the present disclosure with reference to accompanying drawings in the exemplary embodiments of the present disclosure. Apparently, the described exemplary embodiments are merely a part rather than all of the embodiments of the present disclosure. All other embodiments obtained by a person of ordinary skill in the art based on these embodiments of the present disclosure without creative efforts shall fall within the scope of protection of the present disclosure.

Currently, images outputted by a digital camera through an image sensor are mostly Bayer images in a monochromatic format, for example, (R/Gr/Gb/B), (Gr/R/B/Gb), (Gb/B/R/Gr), and (B/Gb/Gr/R). When a high-speed interface receives an image from the image sensor, it is possible to miss one row or one column, causing the Bayer image to change. Therefore, row missing or column missing of a Bayer image needs to be detected in time, so as to facilitate a timely correction of the Bayer image.

Rows of a Bayer image are usually counted to determine whether an image frame has a row missing. However, in the row counting method, the number of rows in each image frame can be compared with the number of rows of an image sensor only after the transmission of the image frame is ended, which leads to low detection efficiency and low correction efficiency.

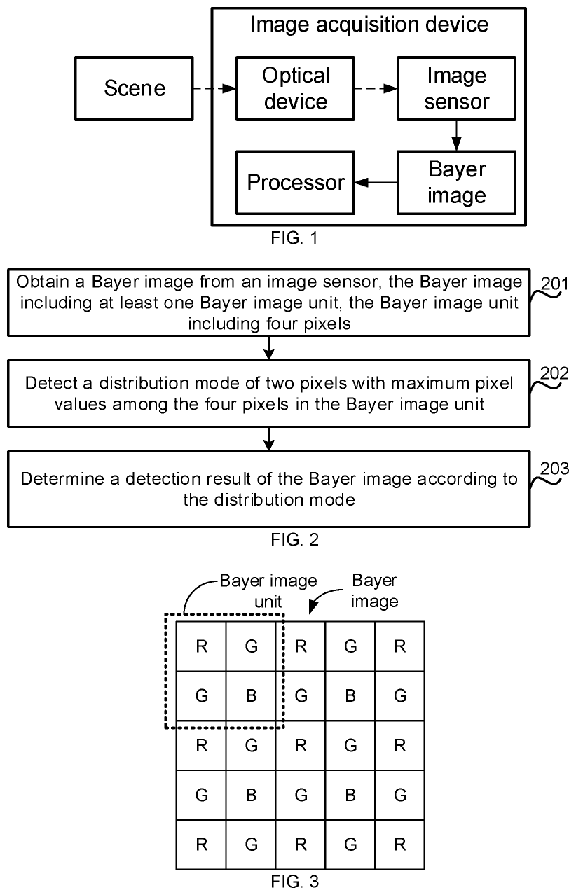

Therefore, some exemplary embodiments of the present disclosure provide a Bayer image detection method. FIG. 1 is a diagram of an application scenario of a Bayer image detection method according to some exemplary embodiments of the present disclosure. The Bayer image detection method provided in some exemplary embodiments of the present disclosure may be applied to an image acquisition device. The image acquisition device may be an electronic device such as a camera or a surveillance camera, or may be a mobile device, such as an unmanned aerial vehicle, a control terminal, a tablet computer, or a smartphone.

Referring to FIG. 1, the light in a scenario reaches an image sensor through an optical device. The image sensor may sense the light and generate a Bayer image, and then output the generated Bayer image to a cache (or a processor) according to a control signal (from the external or the processor). If the Bayer image is outputted to the cache, the processor needs to read the Bayer image from the cache, and then detect the Bayer image according to the Bayer image detection method provided in some exemplary embodiments of the present disclosure. In this case, the processor and the image sensor may belong to different devices. For example, the image sensor may be a camera on an unmanned aerial vehicle. Subsequently, the camera sends a Bayer image to a ground end, so that the processor at the ground end detects the Bayer image according to the Bayer image detection method provided in some exemplary embodiments of the present disclosure, which can also implement the solution of this disclosure.

A Bayer image detection method provided in some exemplary embodiments of the present disclosure will be described below with an example in which the image sensor and the processor belong to the same image acquisition device and the image sensor sends a Bayer image directly to the processor. FIG. 2 is a schematic flowchart of a Bayer image detection method according to some exemplary embodiments of the present disclosure. Referring to FIG. 2, a Bayer image detection method includes the following steps:

201: obtain a Bayer image from an image sensor, where the Bayer image includes at least one Bayer image unit, and each of the at least one Bayer image unit includes four pixels.

In some exemplary embodiments, the processor may obtain the Bayer image from the image sensor. The Bayer image may be obtained in the following manners:

In a first manner, when the processor is connected to the image sensor, the processor obtains the Bayer image directly from the image sensor.

In a second manner, when the processor is not connected to the image sensor, the image sensor may output the Bayer image to a cache for storage, and then the processor may read the Bayer image from the cache.

It should be noted that, in some exemplary embodiments, the Bayer image may include at least one Bayer image unit, and each of the at least one Bayer image unit may include four pixels.

FIG. 3 is a schematic diagram of a part of a Bayer image according to some exemplary embodiments of the present disclosure. Referring to FIG. 3, the Bayer image includes a plurality of Bayer image units, and each Bayer image unit includes four pixels, namely, a red pixel R, a green pixel Gr (the pixel G in the same row with pixel R), a green pixel Gb (the pixel G in the same row with pixel B), and a blue pixel B. The green pixel Gr is related to the red pixel R, and the green pixel Gb is related to the blue pixel B. For the method of calculating the green pixel Gr based on the red pixel R and calculating the green pixel Gb based on the blue pixel B, reference may be made to the related technologies.

For ease of description, Gr and Gb are represented by the letter G in the subsequent drawings, where the subscript of the letter G (r or b) is the same as the red pixel R or the blue pixel B in the same row.

202: detect a distribution mode of two pixels with maximum pixel values among the four pixels in the Bayer image unit.

First, the processor obtains a Bayer image unit from the Bayer image. For example, the processor may directly use four received pixel cells (a red pixel R, a green pixel Gr, a green pixel Gb, and a blue pixel B) as a Bayer image unit. In another example, the processor may call a preset detection window, where the detection window may be as shown by the dashed box in FIG. 3, and four pixels in the detection window are then used as a Bayer image unit.

Then, the processor obtains pixel values of the pixels in the Bayer image unit. It should be noted that, since the image sensor is highly responsive to green, the pixel values of the green pixel Gr and the green pixel Gb may be greater than the pixel values of the red pixel R and the blue pixel B.

Next, the processor may compare the pixel values of the four pixels, and then obtain two pixels with maximum pixel values as well as positions of the foregoing two pixels with the maximum pixel values in the four pixels based on the comparison result, thereby obtaining a distribution mode of the two pixels with the maximum pixel values. In this case, the two pixels with the maximum pixel values may be obtained as follows: first determining a pixel with a maximum pixel value among the four pixels and a position of the pixel with the maximum pixel value; then after removing the pixel with the maximum pixel value, determining another pixel with a maximum pixel value among the remaining three pixels and a position of this pixel with the maximum pixel value.

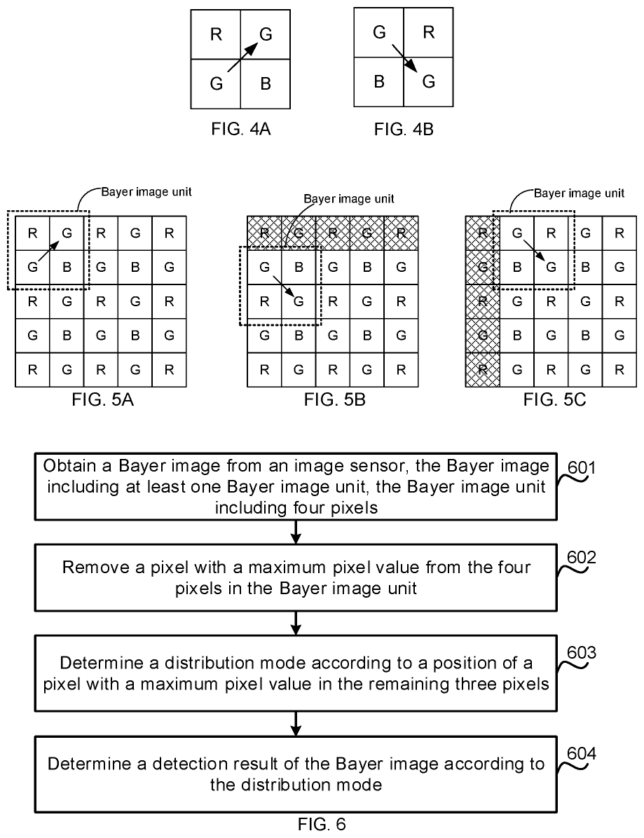

Referring to FIG. 4A and FIG. 4B, the distribution mode of the two pixels with the maximum pixel values may include:

A P mode, which refers to pixel value distribution associated with the second pixel from the left in the first row and the first pixel from the left in the second row. For illustration purpose, the P mode is expressed by connecting line between the second pixel from the left in the first row and the first pixel from the left in the second row, where the connecting line is as shown in FIG. 4A; and

An N mode, which refers to pixel value distribution associated with the first pixel from the left in the first row and the second pixel from the left in the second row. For illustration purpose, the P mode is expressed by a connecting line between the first pixel from the left in the first row and the second pixel from the left in the second row, where the connecting line is as shown in FIG. 4B.

Based on the definition of the distribution mode, when detecting that positions of the two pixels with the maximum pixel values are the second pixel from the left in the first row and the first pixel from the left in the second row, the processor may determine that the distribution mode is the P mode. Alternatively, when detecting that positions of the two pixels with the maximum pixel values are the first pixel from the left in the first row and the second pixel from the left in the second row, the processor determines that the distribution mode is the N mode.

203: determine a detection result of the Bayer image based on the distribution mode.

Referring to FIG. 5A to FIG. 5C, FIG. 5A shows four pixels in a Bayer image unit and positions of the pixels under normal conditions. Since the image sensor is highly responsive to green, the pixel values of the green pixel Gr and the green pixel Gb are greater than the pixel values of the red pixel R and the blue pixel B. Therefore, the two pixels with the maximum pixel values should be the green pixel Gr and the green pixel Gb, which are at the positions of the second pixel from the left in the first row and the first pixel from the left in the second row respectively. The distribution mode of the two pixels with the maximum pixel values is the P mode.

FIG. 5B shows four pixels in a Bayer image unit and positions of the pixels after one row of pixels of the Bayer image is missing (the first row in FIG. 5A, which is marked with shadow). In this case, the two pixels with the maximum pixel values should be the green pixel Gb and the green pixel Gr, which are at the positions of the first pixel from the left in the first row and the second pixel from the left in the second row respectively. The distribution mode of the two pixels with the maximum pixel values is the N mode.

FIG. 5C shows four pixels in a Bayer image unit and positions of the pixels after one column of pixels of the Bayer image is missing (the first column in FIG. 5A, which is marked with shadow). In this case, the two pixels with the maximum pixel values should be the green pixel Gr and the green pixel Gb, which are at the positions of the first pixel from the left in the first row and the second pixel from the left in the second row respectively. The distribution mode of the two pixels with the maximum pixel values is the N mode.

Based on the above analysis on FIG. 5A to FIG. 5C, accordingly, in some exemplary embodiments, the processor may determine the detection result of the Bayer image based on the distribution mode of the two pixels with the maximum pixel values, including:

if the distribution mode is the N mode, indicating that one row of pixels or one column of pixels in the Bayer image is missing, the processor may determine that the detection result of the status of the Bayer image is “error”.

if the distribution mode is the P mode, the Bayer image may be correct or may have one row and one column missing at the same time. Therefore, further detection is needed, which will be described in detail in the subsequent exemplary embodiments, and details are not described herein.

It can be learned that in some exemplary embodiments, after a distribution mode of two pixels with maximum pixel values among four pixels in a Bayer image unit is detected, a detection result of the Bayer image is determined based on the distribution mode. In this way, in some exemplary embodiments, it is unnecessary to detect the entire image, and it can be determined, based on merely one Bayer image unit, whether the Bayer image has a missing row or missing column, thereby achieving the effect of quickly detecting an error in the Bayer image. In addition, in some exemplary embodiments, because the error is positioned based on the Bayer image units in each row or each column, the error in the Bayer image can be positioned quickly, which helps increase correction efficiency of the Bayer image.

Some exemplary embodiments of the present disclosure further provide a Bayer image detection method. FIG. 6 is a schematic flowchart of a Bayer image detection method according to some exemplary embodiments of the present disclosure. In these exemplary embodiments, the application scenario of the Bayer image detection method is the same as the application scenario of the Bayer image detection method shown in FIG. 2, and details are not described herein again. Referring to FIG. 6, a Bayer image detection method includes the following steps:

601: obtain a Bayer image from an image sensor, where the Bayer image includes at least one Bayer image unit, and each of the at least one Bayer image unit includes four pixels.

The specific method and principle of step 601 are the same as those of step 201. For detailed descriptions, reference may be made to the related content in FIG. 2 and step 201. Details are not described herein again.

602: remove a pixel with a maximum pixel value from the four pixels in the Bayer image unit.

In practical application, the Bayer image may be an image of a pure color, an image with a high color temperature, or an image with a low color temperature. The pure color and the high or low color temperature may affect the image sensor, causing the pixel value of the red pixel R or the blue pixel B to be greater than the pixel values of the green pixels Gr and Gb. In other words, pixels with maximum pixel values among the four pixels in the Bayer image unit are no longer the green pixels to which the image sensor is highly responsive. Therefore, in some exemplary embodiments, the processor removes a pixel with a maximum pixel value from the four pixels of the Bayer image unit, to prevent the accuracy of the detection result from being lowered by the pure color, the high or low color temperature.

603: determine a distribution mode according to a position of a pixel with a maximum pixel value in the remaining three pixels.

In some exemplary embodiments, that the processor obtains a position of a pixel with a maximum pixel value in the remaining three pixels, and may determine the distribution mode based on the position of the pixel with the maximum pixel value may include:

if the pixel with the maximum pixel value among the remaining three pixels is the second pixel from the left in the first row or the first pixel from the left in the second row, the processor may determine that the distribution mode is the P mode; and

if the pixel with the maximum pixel value in the remaining three pixels is the first pixel from the left in the first row or the second pixel from the left in the second row, the processor may determine that the distribution mode is the N mode.

It should be noted that, for the content corresponding to the distribution mode, reference may be made to the content shown in step 202, and details are not described herein again.

604: determine a detection result of the Bayer image based on the distribution mode.

The specific method and principle of step 604 are the same as those of step 203. For detailed descriptions, reference may be made to the related content in FIG. 2 and step 203. Details are not described herein again.

It can be learned that, in addition to quickly detecting an error in the Bayer image and positioning the error in the Bayer image, some exemplary embodiments can further improve the accuracy of error detection and error positioning, thereby further improving the correction efficiency of the Bayer image.

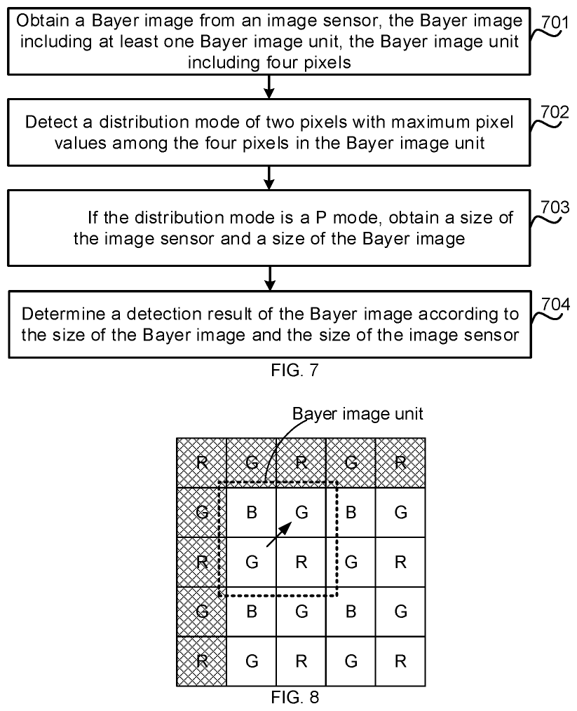

Some exemplary embodiments of the present disclosure further provide a Bayer image detection method. FIG. 7 is a schematic flowchart of a Bayer image detection method according to some exemplary embodiments of the present disclosure. In these exemplary embodiments, the application scenario of the Bayer image detection method is the same as the application scenario of the Bayer image detection method shown in FIG. 2, and details are not described herein again. Referring to FIG. 7, a Bayer image detection method includes the following steps:

701: obtain a Bayer image from an image sensor, where the Bayer image includes at least one Bayer image unit, and each of the at least one Bayer image unit includes four pixels.

The specific method and principle of step 701 are the same as those of step 201. For detailed descriptions, reference may be made to the related contents in FIG. 2 and step 201. Details are not described herein again.

702: detect a distribution mode of two pixels with maximum pixel values among the four pixels in the Bayer image unit.

The specific method and principle of step 702 are the same as those of step 202. For detailed descriptions, reference may be made to the related contents of FIG. 2 and step 202. Details are not described herein again.

703: if the distribution mode is a P mode, obtain a size of the image sensor and a size of the Bayer image.

In practical application, a row of pixels and a column of pixels in a Bayer image may be missing at the same time. Referring to FIG. 8, based on the Bayer image shown in FIG. 5A, the first row of pixels and the first column of pixels in the Bayer image are missing (the missing pixels are marked with shadow). In this case, the four pixels in the Bayer image unit obtained by the processor are a blue pixel B, a green pixel G, a green pixel G, and a red pixel R in order, and two pixels with maximum pixel values are the second pixel from the left in the first row and the first pixel from the left in the second row, that is, the distribution mode is the P mode.

With reference to FIG. 5A and FIG. 8, the P mode corresponds to two situations: the Bayer image is normal and the Bayer image has one row and one column missing at the same time. To improve the accuracy of the detection result, in some exemplary embodiments, the processor further obtains the size of the image sensor and the size of the Bayer image. The size of the image sensor (for example, n rows*m columns) may be stored in a memory in advance, and the processor may directly read the size of the image sensor from the memory based on an identification code of the image sensor. The size of the Bayer image may be counted by the processor during each detection process, and the obtained statistical result can be used as the current size of the Bayer image. For example, during the detection in a row direction, the processor may count the number of pixels m in one or each row of the Bayer image; alternatively, during the detection in a column direction, the processor may count the number of pixels n in one or each column of the Bayer image.

704: determine a detection result of the Bayer image based on the size of the Bayer image and the size of the image sensor.

In some exemplary embodiments, the processor compares the size of the Bayer image with the size of the image sensor, to determine whether the number of pixels in one or each row (or a column) of the Bayer image is the same as the number of pixels in the corresponding row (or each column) of the image sensor. Subsequently, the number of pixels in the rows is taken as an example for description. The conception of the number of pixels in the column is the same as the conception of the number of pixels in the row, and is not described in detail again.

If the number of pixels in one or each row of the Bayer image is the same as the number of pixels in the corresponding row of the image sensor, it indicates that the number of columns of the Bayer image is the same as that of the image sensor, that is, the Bayer image has no pixel missing in the column direction, and the processor may determine that the detection result of the status of the Bayer image is “correct”.

If the number of pixels in one or each row of the Bayer image is less than the number of pixels in the corresponding row of the image sensor (that is, the Bayer image and the image sensor have different numbers of pixels in a row), it indicates that the number of columns of the Bayer image is different from that of the image sensor, that is, the Bayer image has a pixel(s) missing in the column direction, and the processor may determine that the detection result of the status of the Bayer image is “error”.

It can be learned that, in addition to quickly detecting an error in the Bayer image and positioning the error in the Bayer image, some exemplary embodiments can further improve the accuracy of error detection and error positioning, thereby further improving the correction efficiency of the Bayer image.

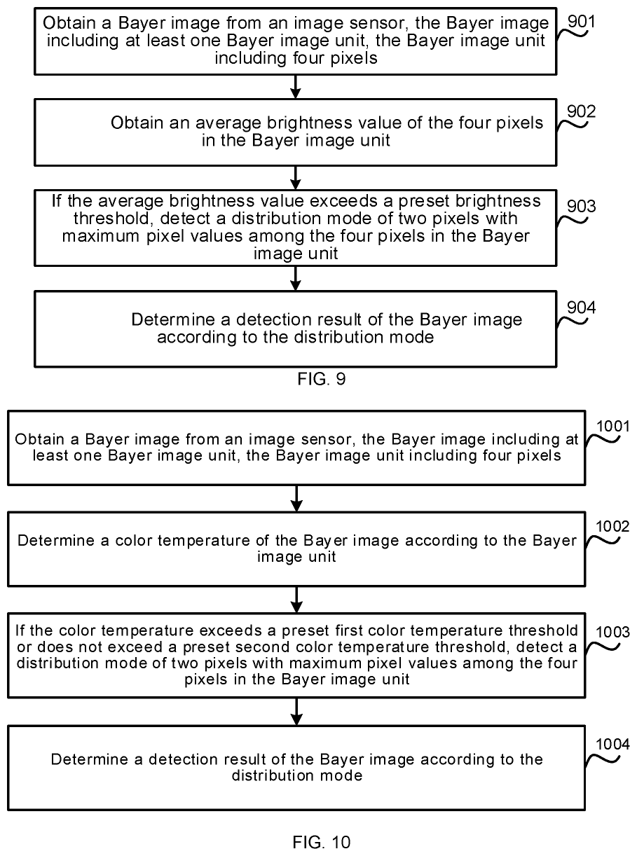

Some exemplary embodiments of the present disclosure further provide a Bayer image detection method. FIG. 9 is a schematic flowchart of a Bayer image detection method according to some exemplary embodiments of the present disclosure. In these exemplary embodiments, the application scenario of the Bayer image detection method is the same as the application scenario of the Bayer image detection method shown in FIG. 2, and details are not described herein again. Referring to FIG. 9, a Bayer image detection method includes the following steps:

901: obtain a Bayer image from an image sensor, where the Bayer image includes at least one Bayer image unit, and each of the at least one Bayer image unit includes four pixels.

The specific method and principle of step 901 are the same as those of step 201. For detailed descriptions, reference may be made to the related contents in FIG. 2 and step 201. Details are not described herein again.

902: obtain an average brightness value of the four pixels in the Bayer image unit.

The Bayer image may be an image with a pure black part(s) or an image that is entirely pure black. In a pure black region, the pixel values of the four pixels in the Bayer image unit are almost the same. As a result, the processor cannot detect the Bayer image based on the pixel values. Therefore, in some exemplary embodiments, the pixels in the Bayer image unit may further include brightness values in addition to the pixel values. In this way, the processor may obtain the brightness values of the pixels in the Bayer image unit, and then obtain an average brightness value of the four pixels; subsequently, it is determined, by using the average brightness value as a parameter, whether to detect the Bayer image.

903: if the average brightness value exceeds a preset brightness threshold, detect a distribution mode of two pixels with maximum pixel values among the four pixels in the Bayer image unit.

In some exemplary embodiments, when the average brightness value does not exceed the preset brightness threshold, the processor stops the current detection and moves to the next Bayer image unit.

Alternatively, when the average brightness value exceeds the preset brightness threshold, the processor performs the step of detecting a distribution mode of two pixels with maximum pixel values among the four pixels in the Bayer image unit. The specific method and principle of detecting the distribution mode by the processor are the same as those of step 202. For detailed descriptions, reference may be made to the related contents in FIG. 2 and step 202. Alternatively, the specific method and principle of detecting the distribution mode by the processor are the same as those of step 602 and step 603. For detailed descriptions, reference may be made to the related contents in FIG. 6, and step 602 and step 603.

904: determine a detection result of the Bayer image based on the distribution mode.

The specific method and principle of step 904 are the same as those of step 203. For detailed descriptions, reference may be made to the related contents in FIG. 2 and step 203. Details are not described herein again.

It can be learned that, in addition to quickly detecting an error in the Bayer image and positioning the error in the Bayer image, some exemplary embodiments can further improve the accuracy of error detection and error positioning, thereby further improving the correction efficiency of the Bayer image.

Some exemplary embodiments of the present disclosure further provide a Bayer image detection method. FIG. 10 is a schematic flowchart of a Bayer image detection method according to some exemplary embodiments of the present disclosure. In these exemplary embodiments, the application scenario of the Bayer image detection method is the same as the application scenario of the Bayer image detection method shown in FIG. 2, and details are not described herein again. Referring to FIG. 10, a Bayer image detection method includes the following steps:

1001: obtain a Bayer image from an image sensor, where the Bayer image includes at least one Bayer image unit, and each of the at least one Bayer image unit includes four pixels.

The specific method and principle of step 1001 are the same as those of step 201. For detailed descriptions, reference may be made to the related contents in FIG. 2 and step 201. Details are not described herein again.

1002: determine a color temperature of the Bayer image based on the Bayer image unit.

It should be noted that, the color temperature is a measurement of color components in light. Theoretically, the color temperature refers to the color exhibited by an absolute black body after it is heated from absolute zero (−273° C.). In addition, the color temperature only represents spectral components of a light source, but does not represent its light intensity. For example, a high color temperature indicates more short-wave components, and the light looks bluish green; a low color temperature indicates more long-wave components, and the light looks reddish yellow.

Therefore, the processor may determine the color temperature of the Bayer image based on the color temperature of the Bayer image unit.

1003: if the color temperature exceeds a preset first color temperature threshold or does not exceed a preset second color temperature threshold, detect a distribution mode of two pixels with maximum pixel values among the four pixels in the Bayer image unit.

In some exemplary embodiments, the first color temperature threshold and the second color temperature threshold are set in advance. The first color temperature threshold is lower than the second color temperature threshold. That is, when the color temperature of the Bayer image is lower than the first color temperature threshold, the Bayer image is reddish or even pure red; when the color temperature of the Bayer image exceeds the second color temperature threshold, the Bayer image is bluish or even pure blue.

Therefore, the processor may not detect a Bayer image whose color temperatures is lower than the first color temperature threshold or higher than the second color temperature threshold. For a Bayer image whose color temperature exceeds the preset first color temperature threshold but does not exceed the preset second color temperature threshold, the processor performs the step of detecting a distribution mode of two pixels with maximum pixel values among the four pixels in the Bayer image unit.

The specific method and principle of detecting the distribution mode by the processor are the same as those of step 202. For detailed descriptions, reference may be made to the related contents in FIG. 2 and step 202. Alternatively, the specific method and principle of detecting the distribution mode by the processor are the same as those of step 602 and step 603. For detailed descriptions, reference may be made to the related content of FIG. 6 and step 602 and step 603.

1004: determine a detection result of the Bayer image according to the distribution mode.

The specific method and principle of step 1004 are the same as those of step 203. For detailed descriptions, reference may be made to the related contents in FIG. 2 and step 203. Details are not described herein again.

It can be learned that, in addition to quickly detecting an error in the Bayer image and positioning the error in the Bayer image, some exemplary embodiments can further improve the accuracy of error detection and error positioning, thereby further improving the correction efficiency of the Bayer image.

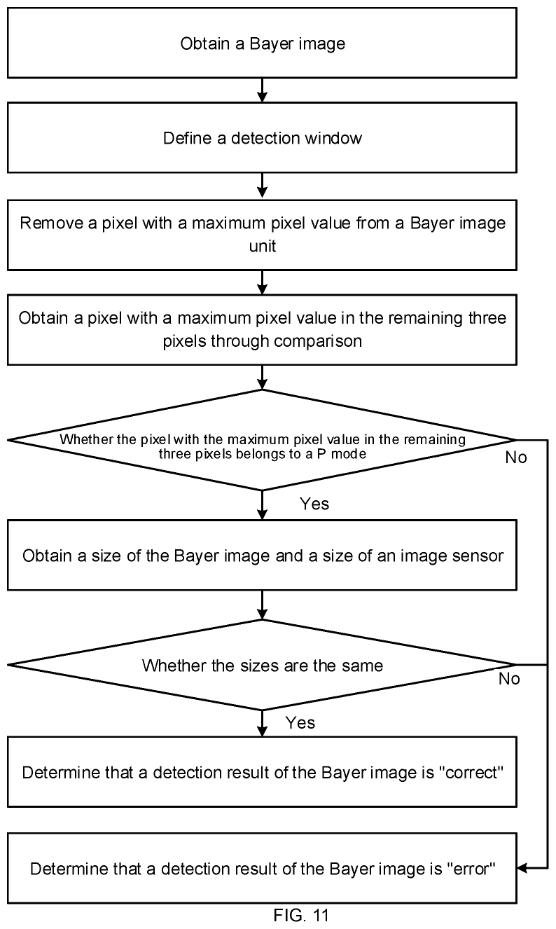

A Bayer image detection method provided in some exemplary embodiments of the present disclosure will be described below with reference to these exemplary embodiments and an accompanying drawing. FIG. 11 is a schematic flowchart of a Bayer image detection method according to some exemplary embodiments of the present disclosure. Referring to FIG. 11, the processor may interact with the image sensor to obtain a Bayer image and define a detection window. Then, the processor may move the detection window on the Bayer image to obtain a Bayer image unit. Next, the processor removes a pixel with a maximum pixel value from the Bayer image unit, and obtains a pixel with a maximum pixel value among the remaining pixels through comparison. Based on the P mode and the N mode, a distribution mode of the pixel with maximum pixel value in the remaining three pixels may be obtained. If it is not the P mode, the processor determines that a detection result of the Bayer image is “error”; if it is the P mode, the processor obtains a size of the image sensor and a size of the Bayer image, and compares these two sizes. If these two sizes are different, the processor determines that the detection result of the status of the Bayer image is “error”; if these two sizes are the same, the processor determines that the detection result of the status of the Bayer image is “correct”.

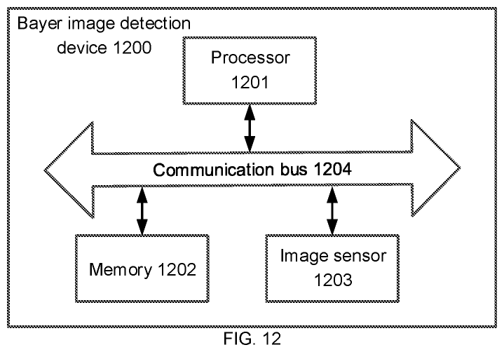

Some exemplary embodiments of the present disclosure further provide a Bayer image detection device. Referring to FIG. 12, the Bayer image detection device includes at least one processor 1201, at least one memory (storage device) 1202, an image sensor 1203, and a communication bus 1204. The image sensor 1204 is connected to the processor 1201 and configured to acquire a Bayer image and send the Bayer image to the processor 1201; the memory (storage device) 1202 is connected to the processor 1201 and configured to store computer instructions of a Bayer image detection method executable by the at least one processor 1201; and the at least one processor 1201 is configured to read the computer instructions from the memory 1202 to implement the following operations:

obtaining a Bayer image from an image sensor, where the Bayer image includes at least one Bayer image unit, and each of the at least one Bayer image unit includes four pixels;

detecting a distribution mode of two pixels with maximum pixel values among the four pixels in the Bayer image unit; and

determining a detection result of the Bayer image based on the distribution mode.

In some exemplary embodiments, the distribution mode includes a P mode or an N mode;

the P mode refers to a connecting line between the second pixel from the left in the first row and the first pixel from the left in the second row; and

the N mode refers to a connecting line between the first pixel from the left in the first row and the second pixel from the left in the second row.

In some exemplary embodiments, the processor 1201 being configured to detect a distribution mode of two pixels with maximum pixel values among the four pixels in the Bayer image unit includes:

if it is detected that positions of the two pixels with the maximum pixel values are the second pixel from the left in the first row and the first pixel from the left in the second row, determining that the distribution mode is the P mode; or

if it is detected that positions of the two pixels with the maximum pixel values are the first pixel from the left in the first row and the second pixel from the left in the second row, determining that the distribution mode is the N mode.

In some exemplary embodiments, the processor 1201 being configured to detect a distribution mode of two pixels with maximum pixel values among the four pixels in the Bayer image unit includes:

removing a pixel with a maximum pixel value from the four pixels in the Bayer image unit; and

determining the distribution mode based on a position of a pixel with a maximum pixel value in the remaining three pixels.

In some exemplary embodiments, the processor 1201 being configured to determine the distribution mode according to a position of a pixel with a maximum pixel value in the remaining three pixels includes:

if the pixel with the maximum pixel value in the remaining three pixels is the second pixel from the left in the first row or the first pixel from the left in the second row, determining that the distribution mode is the P mode; and

if the pixel with the maximum pixel value in the remaining three pixels is the first pixel from the left in the first row or the second pixel from the left in the second row, determining that the distribution mode is the N mode.

In some exemplary embodiments, the processor 1201 being configured to determine a detection result of the Bayer image according to the distribution mode includes:

if the distribution mode is an N mode, determining that the detection result of the status of the Bayer image is “error”.

In some exemplary embodiments, the processor 1201 being configured to determine a detection result of the Bayer image according to the distribution mode includes:

if the distribution mode is a P mode, obtaining a size of the image sensor and a size of the Bayer image; and

determining the detection result of the Bayer image based on the size of the Bayer image and the size of the image sensor.

In some exemplary embodiments, the processor 1201 being configured to determine the detection result of the Bayer image according to the size of the Bayer image and the size of the image sensor includes:

if the number of pixels in one or each row in the Bayer image is less than the number of pixels in the corresponding row in the image sensor, determining that the detection result of the status of the Bayer image is “error”; and

if the number of pixels in one or each row in the Bayer image is equal to the number of pixels in the corresponding row in the image sensor, determining that the detection result of the status of the Bayer image is “correct”.

In some exemplary embodiments, the processor 1201 is further configured to:

obtain an average brightness value of the four pixels in the Bayer image unit; and

if the average brightness value exceeds a preset brightness threshold, perform the step of detecting a distribution mode of two pixels with maximum pixel values among the four pixels in the Bayer image unit.

In some exemplary embodiments, the processor 1201 is further configured to:

determine a color temperature of the Bayer image based on the Bayer image unit; and

if the color temperature exceeds a preset first color temperature threshold or does not exceed a preset second color temperature threshold, perform the step of detecting a distribution mode of two pixels with maximum pixel values among the four pixels in the Bayer image unit.

In some exemplary embodiments, the processor 1201 is configured to obtain each Bayer image unit in the Bayer image through a detection window.

Some exemplary embodiments of the present disclosure further provide a machine readable storage medium. The machine readable storage medium stores a plurality of computer instructions, and the computer instructions, when being executed, implement the steps of one of the Bayer image detection methods in FIG. 2 to FIG. 11.

It should be noted that, in this disclosure, relationship terms such as first and second are only used to distinguish an entity or operation from another entity or operation, but do not necessarily require or imply that there is any actual relationship or order between these entities or operations. In addition, terms “include”, “comprise”, or any other variations thereof are intended to cover non-exclusive including, so that a process, a method, an article, or a device including a series of elements not only includes those elements, but also includes other elements that are not explicitly listed, or also includes inherent elements of the process, the method, the article, or the device. Without more restrictions, the elements defined by the phrase “including a . . . ” do not exclude the existence of other identical elements in the process, method, article, or device including the elements.

The detection method and apparatus provided by some exemplary embodiments of the present disclosure are described in detail above. The principles and implementations of the present disclosure are described with reference to specific examples. The description of the exemplary embodiments is merely provided to help understand the method and core idea of the present disclosure. In addition, a person of ordinary skill in the art can make variations and modifications on the specific implementations and application scopes based on the idea of the present disclosure. Therefore, content of this disclosure shall not be construed as a limitation on the present disclosure.

What is claimed is:

1. A Bayer image detection method, comprising:
obtaining a Bayer image from an image sensor, wherein the Bayer image includes at least one Bayer image unit, and each of the at least one Bayer image unit includes four pixels;
detecting a distribution mode of two pixels with maximum pixel values among the four pixels in the Bayer image unit; and
determining a detection result of a status of the Bayer image based on the distribution mode.

2. The method according to claim 1, wherein the four pixels is distributed as a 2×2 matrix; and
the distribution mode includes:
a P mode, which is related with pixel value distribution associated with a second pixel from the left in a first row of the matrix and a first pixel from the left in a second row of the matrix, and
an N mode, which is related with pixel value distribution associated with pixel status of a first pixel from the left in the first row and a second pixel from the left in the second row.

3. The method according to claim 2, wherein the detecting of the distribution mode of the two pixels with the maximum pixel values among the four pixels in the Bayer image unit includes:
upon detecting that the two pixels with the maximum pixel values are the second pixel from the left in the first row and the first pixel from the left in the second row, determining that the distribution mode is the P mode; or
upon detecting that the two pixels with the maximum pixel values are the first pixel from the left in the first row and the second pixel from the left in the second row, determining that the distribution mode is the N mode.

4. The method according to claim 2, wherein the detecting of the distribution mode of the two pixels with the maximum pixel values among the four pixels in the Bayer image unit includes:
removing a pixel with a maximum pixel value from the four pixels in the Bayer image unit; and
determining the distribution mode based on pixel values of remaining three pixels of the four pixels.

5. The method according to claim 4, wherein the determining of the distribution mode based on the pixel values of the remaining three pixels includes:
upon detecting that the pixel with the maximum pixel value in the remaining three pixels is the second pixel from the left in the first row or the first pixel from the left in the second row, determining that the distribution mode is the P mode; or
upon detecting that the pixel with the maximum pixel value in the remaining three pixels is the first pixel from the left in the first row or the second pixel from the left in the second row, determining that the distribution mode is the N mode.

6. The method according to claim 2, wherein the determining of the detection result of the status of the Bayer image based on the distribution mode includes:
upon determining that the distribution mode is an N mode, determining that the detection result of the status of the Bayer image is “error”.

7. The method according to claim 2, wherein the determining of the detection result of the status of the Bayer image based on the distribution mode includes:
upon determining that the distribution mode is a P mode, obtaining a size of the image sensor and a size of the Bayer image; and
determining the detection result of the status of the Bayer image based on the size of the Bayer image and the size of the image sensor.

8. The method according to claim 7, wherein the determining of the detection result of the status of the Bayer image based on the size of the Bayer image and the size of the image sensor includes:
upon determining that the number of pixels in at least one of a row or a column in the Bayer image is less than the number of pixels in the corresponding row or column in the image sensor, determining that the detection result of the status of the Bayer image is “error”; or
upon determining that the number of pixels in at least one of a row or a column in the Bayer image is equal to the number of pixels in the corresponding row or column in the image sensor, determining that the detection result of the status of the Bayer image is “correct”.

9. The method according to claim 1, further comprising:
obtaining an average brightness value of the four pixels in the Bayer image unit, and upon determining that the average brightness value exceeds a preset brightness threshold, detecting the distribution mode of the two pixels with the maximum pixel values among the four pixels in the Bayer image unit; or
determining a color temperature of the Bayer image based on the Bayer image unit, and upon determining that the color temperature exceeds a preset first color temperature threshold or does not exceed a preset second color temperature threshold, detecting the distribution mode of the two pixels with the maximum pixel values among the four pixels in the Bayer image unit, wherein the first color temperature threshold is lower than the second color temperature threshold.

10. The method according to claim 1, wherein each of the at least one Bayer image unit in the Bayer image is obtained through a detection window.

11. A Bayer image detection device, comprising:
an image sensor;
at least one storage device storing a set of instructions for detecting a Bayer image; and
at least one processor in communication with the at least one storage device, wherein during operation, the at least one processor executes the set of instructions to:
obtain a Bayer image from the image sensor, wherein the Bayer image includes at least one Bayer image unit, and each of the at least one Bayer image unit includes four pixels;
detect a distribution mode of two pixels with maximum pixel values among the four pixels in the Bayer image unit; and
determining a detection result of a status of the Bayer image based on the distribution mode.

12. The device according to claim 11, wherein the four pixels is distributed as a 2×2 matrix; and
the distribution mode includes:
a P mode, which is related with pixel value distribution associated with a second pixel from the left in a first row of the matrix and a first pixel from the left in a second row of the matrix, and
an N mode, which is related with pixel value distribution associated with pixel status of a first pixel from the left in the first row and a second pixel from the left in the second row.

13. The device according to claim 12, wherein to detect the distribution mode of the two pixels with the maximum pixel values among the four pixels in the Bayer image unit includes:
upon detecting that the two pixels with the maximum pixel values are the second pixel from the left in the first row and the first pixel from the left in the second row, determining that the distribution mode is the P mode; or
upon detecting that the two pixels with the maximum pixel values are the first pixel from the left in the first row and the second pixel from the left in the second row, determining that the distribution mode is the N mode.

14. The device according to claim 12, wherein to detect the distribution mode of the two pixels with the maximum pixel values among the four pixels in the Bayer image unit includes:
to remove a pixel with a maximum pixel value from the four pixels in the Bayer image unit; and
to determine the distribution mode based on pixel values of remaining three pixels of the four pixels.

15. The device according to claim 14, wherein to determine the distribution mode based on the pixel values of the remaining three pixels includes:
upon detecting that the pixel with the maximum pixel value in the remaining three pixels is the second pixel from the left in the first row or the first pixel from the left in the second row, determining that the distribution mode is the P mode; or
upon detecting that the pixel with the maximum pixel value in the remaining three pixels is the first pixel from the left in the first row or the second pixel from the left in the second row, determining that the distribution mode is the N mode.

16. The device according to claim 12, wherein to determine the detection result of the Bayer image based on the distribution mode includes:
upon determining that the distribution mode is an N mode, determining that the detection result of the status of the Bayer image is “error”.

17. The device according to claim 12, wherein to determine the detection result of the Bayer image based on the distribution mode includes:
upon determining that the distribution mode is a P mode, obtaining a size of the image sensor and a size of the Bayer image; and
determining the detection result of the status of the Bayer image based on the size of the Bayer image and the size of the image sensor.

18. The device according to claim 17, wherein to determine the detection result of the Bayer image based on the size of the Bayer image and the size of the image sensor includes:
upon determining that the number of pixels in at least one of a row or a column in the Bayer image is less than the number of pixels in the corresponding row or column in the image sensor, determining that the detection result of the status of the Bayer image is “error”; or
upon determining that the number of pixels in at least one of a row or a column in the Bayer image is equal to the number of pixels in the corresponding row or column in the image sensor, determining that the detection result of the status of the Bayer image is “correct”.

19. The device according to claim 11, wherein the at least one processor further executes the set of instructions to:
obtain an average brightness value of the four pixels in the Bayer image unit, and upon determining that the average brightness value exceeds a preset brightness threshold, detecting the distribution mode of the two pixels with the maximum pixel values among the four pixels in the Bayer image unit; or
determine a color temperature of the Bayer image based on the Bayer image unit, and upon determining that the color temperature exceeds a preset first color temperature threshold or does not exceed a preset second color temperature threshold, detecting the distribution mode of the two pixels with the maximum pixel values among the four pixels in the Bayer image unit, wherein the first color temperature threshold is lower than the second color temperature threshold.

20. The device according to claim 11, wherein the at least one processor further executes the set of instructions to:
obtain each of the at least one Bayer image unit in the Bayer image through a detection window.
